(19) United States
(12) Patent Application Publication
(10) Pub. No.: US 2025/0391979 A1
(43) Pub. Date: Dec. 25, 2025

(54) ENERGY STORAGE APPARATUS

(71) Applicant: GS Yuasa International Ltd., Kyoto-shi, Kyoto (JP)

(72) Inventors: Koki MAEDA, Kyoto-shi, Kyoto (JP); Atsuyuki KONISHI, Kyoto-shi, Kyoto (JP); Yasuyuki IWASHIMA, Kyoto-shi, Kyoto (JP)

(21) Appl. No.: 18/840,618

(22) PCT Filed: Feb. 9, 2023
(86) PCT No.: PCT/JP2023/004344

§ 371 Date: Apr. 16, 2025

(30) Foreign Application Priority Data
Mar. 16, 2022 (JP) 2022-041782

(51) Int. Cl. H01M 50/209; H01M 50/291

(52) U.S. Cl. CPC H01M 50/209; H01M 50/291

(57) ABSTRACT

An energy storage apparatus includes an energy storage device unit that includes a plurality of energy storage devices arrayed in a first direction and an outer case accommodating the energy storage device unit. The outer case includes an opening at an end in a second direction orthogonal to the first direction. The outer case includes a bottom wall opposite to the opening and a side wall connected to the bottom wall. The side wall is opposite to the energy storage device unit in the first direction, and is inclined in a direction away from the energy storage device unit as the side wall extends farther from the bottom wall. The side wall includes a first vertical surface that is a plane perpendicular to the first direction on at least a part of the inside surface in the second direction. The inside surface is opposite to the energy storage device unit in the first direction.

### TECHNICAL FIELD

The present invention relates to an energy storage apparatus including an outer case.

### BACKGROUND ART

Conventionally, when a box-shaped outer case that is open in one direction is manufactured using a model such as a mold, an inclination is provided in an inside surface of the model in order to easily take out a molded article from the model, and as a result, a gradient (inclination) called a draft angle is generated in a side wall of the outer case. For example, Patent Document 1 discloses an energy storage apparatus including a first outer case that holds at least one energy storage device and a second outer case into which the first outer covering is inserted. The first outer case includes a first vertical wall that surrounds a periphery of the at least one energy storage device, and the second outer case includes a second vertical wall that surrounds the first vertical wall of the first outer case. An outer surface of the first vertical wall is an inclined surface that is inclined so as to be separated from the second vertical wall toward a back side in the insertion direction of the first outer case, and one of the outer surface of the first vertical wall and an inner surface of the second vertical wall includes a protrusion that abuts on the other of the outer surface of the first vertical wall and the inner surface of the second vertical wall.

### PRIOR ART DOCUMENT

### Patent Document

Patent Document 1: JP-A-2014-72088

### SUMMARY OF THE INVENTION

### Problems to be Solved by the Invention

In the above-mentioned conventional energy storage apparatus, the first wall of the first outer case has the draft angle (outwardly inclined). However, for example, when the protrusion is disposed on the outer surface of the first vertical wall, the protrusion is brought into contact with the second vertical wall of the second outer case that accommodates the first outer case, thereby preventing rattling of the first outer case. That is, the problem caused by the inclination of the outer surface of the first vertical wall is solved.

However, in the outer case including the side wall having the draft angle as the first vertical wall, the inner surface of the side wall is also inclined, and a problem caused by the inclined inner surface may be also generated. Specifically, for example, when the energy storage device unit including a plurality of energy storage devices arrayed in a row is accommodated inside the outer case, an end of the energy storage device unit is pressed against the inner surface of the side wall by expansion of at least one energy storage device. The inner surface is inclined in a direction away from the energy storage device unit toward an upper side (outward), whereby the energy storage device unit receives upward force from the inner surface. This upward force may cause upward deviation (displacement) of the energy storage device unit, which may cause a defect.

The present invention has been made by the inventor of the present application to newly focus on the above problems, and an object of the present invention is to provide an energy storage apparatus including an outer case and having improved safety.

### Means for Solving the Problems

An energy storage apparatus according to one aspect of the present invention includes: an energy storage device unit including a plurality of energy storage devices arrayed in a first direction; and an outer case accommodating the energy storage device unit, the outer case including an opening at an end in a second direction orthogonal to the first direction, in which the outer case includes: a bottom wall opposite to the opening in the second direction; and a side wall being connected to the bottom wall and being opposite to the energy storage device unit in the first direction, the side wall being inclined in a direction away from the energy storage device unit as the side wall extends farther from the bottom wall, and the side wall includes a first vertical surface that is a plane perpendicular to the first direction on at least a part of an inside surface in the second direction, the inside surface being opposite to the energy storage device unit in the first direction.

### Advantages of the Invention

According to the present invention, the energy storage apparatus with the improved reliability can be provided.

### BRIEF DESCRIPTION OF THE DRAWINGS

FIG. 1 is a perspective view illustrating an appearance of an energy storage apparatus according to an embodiment.

FIG. 2 is an exploded perspective view illustrating the energy storage apparatus according to the embodiment.

FIG. 3 is an exploded perspective view illustrating an energy storage device unit according to the embodiment.

FIG. 4 is a sectional view illustrating an outer case according to the embodiment.

FIG. 5 is a partially cutaway perspective sectional view illustrating a structural relationship between the outer case and the energy storage device unit according to the embodiment.

FIG. 6 is a sectional view illustrating a structural relationship between the energy storage device unit and a side wall of the outer case according to the embodiment.

### MODE FOR CARRYING OUT THE INVENTION

(1) An energy storage apparatus according to one aspect of the present invention includes: an energy storage device unit including a plurality of energy storage devices arrayed in a first direction; and an outer case accommodating the energy storage device unit, the outer case including an opening at an end in a second direction orthogonal to the first direction, in which the outer case includes: a bottom wall opposite to the opening in the second direction; and a side wall being connected to the bottom wall and being opposite to the energy storage device unit in the first direction, the side wall being inclined in a direction away from the energy storage device unit as the side wall extends farther from the bottom wall, and the side wall includes a first vertical surface being a plane perpendicular to the first direction on at least a part of an inside surface in the second direction, the inside surface being opposite to the energy storage device unit in the first direction.

In the energy storage apparatus according to this aspect, the side wall opposite to the energy storage device unit in the first direction that is the array direction of the energy storage devices is inclined in the direction away from the energy storage device unit as the side wall extends farther from the bottom wall. However, the plane (first vertical surface) perpendicular to the first direction is provided on the inside surface of the side wall. With such the configuration, even when the energy storage device unit expands in the first direction, the side wall can be pushed back by the first vertical surface by reaction force in the direction parallel to the first direction. According to the energy storage apparatus of this aspect, displacement of the energy storage device unit can be prevented while preventing the expansion of the energy storage device unit. As a result, a possibility of generating a defect due to the displacement of the energy storage device unit is reduced. As described above, the energy storage apparatus of the present aspect is a highly reliable energy storage apparatus.

(2) In the energy storage apparatus described in (1), the energy storage device unit may further include an end spacer between the plurality of energy storage devices and the side wall, and the end spacer may include a second vertical surface being a plane perpendicular to the first direction on at least a part of a side surface opposite to the side wall.

With such the configuration, when the energy storage device unit expands in the first direction, the side wall and the energy storage device unit push one another in the first direction while the first vertical surface and the second vertical surface are brought into surface contact with each other. Consequently, the force applied to the side wall by the energy storage device unit is dispersed in the first vertical surface, and the expansion can be stably prevented. Relatively large frictional force generated by the contact between the wide surfaces more reliably prevents movement of the energy storage device unit in the direction away from the bottom wall. As described above, the energy storage apparatus of the present aspect is an energy storage apparatus with higher reliability.

(3) In the energy storage apparatus described in (1) or (2), the energy storage device unit may be inserted into the opening, and an inclined surface may be provided on the inside surface of the side wall at a position continuous to the first vertical surface in the second direction, the inclined surface being inclined in a direction away from the energy storage device unit as the side wall extends farther from the bottom wall.

With such the configuration, the inclined surface is formed on a part of the inside surface of the side wall, so that the inclined surface functions as a guide when the energy storage device unit is inserted into the outer case. With such the configuration, the energy storage device unit can be efficiently accommodated in the outer case. The state in which the energy storage device unit can be inserted into the opening means that the opening may be open such that the energy storage device unit can be inserted into the opening. Even when a slit, an irregularity, or the like that guides the energy storage device unit to the inside of the outer case are formed in the opening, it is sufficient that the energy storage device unit can be inserted into the outer case.

(4) In the energy storage apparatus described in (3), the inclined surface may include a first inclined surface provided at an end far from the bottom wall out of both ends of the inside surface in the second direction.

With such the configuration, the first inclined surface functions as an insertion guide at the start of the work of inserting the energy storage device unit into the opening of the energy storage device unit. When the opening faces upward, an upper end of the first vertical surface is located next to the first inclined surface at an upper end of the side wall. Consequently, the position in the first direction of the first vertical surface is relatively far from the outside surface of the side wall. As a result, even in the case where the side wall is relatively thin, a thickness of the side wall at the end closest to the bottom wall of the first vertical surface can be secured to a thickness that satisfies the requirements of safety and the like. As described above, the energy storage apparatus of the present aspect is an energy storage apparatus with higher reliability.

(5) In the energy storage apparatus described in (3) or (4), the inclined surface includes a second inclined surface provided at an end close to the bottom wall out of both ends of the inside surface in the second direction.

According to this configuration, the second inclined surface is provided at the position close to the bottom wall on the inside surface of the side wall, so that a wall thickness of the side wall at the position of the end in the second direction of the first vertical surface can be ensured to a thickness that satisfies the requirements of safety and the like. As described above, the energy storage apparatus of the present aspect is an energy storage apparatus with higher reliability. The second inclined surface also functions as the insertion guide at the end of the work of inserting the energy storage device unit into the inside of the outer case.

Hereinafter, an energy storage apparatus according to an embodiment (including a modification) of the present invention will be described with reference to the drawings. The embodiment described below indicates a comprehensive or specific example. Numerical values, shapes, materials, components, dispositions and connection forms of the components, manufacturing processes, order of the manufacturing processes, and the like described in the following embodiment are merely examples, and are not intended to limit the present invention. In each of the drawings, dimensions and the like are not strictly illustrated. In the drawings, the same or similar components are denoted by the same reference signs.

In the following description and drawings, a direction in which short side surfaces of the energy storage device are opposite to each other or a longitudinal direction of a lid plate of a container of the energy storage device is defined as a Y-axis direction. The direction in which the plurality of energy storage devices are arrayed or the direction in which a long side surfaces of the energy storage devices are opposite to each other is defined as an X-axis direction. A direction in which a body (outer case body) of the outer case of the energy storage apparatus and the lid body are arrayed or a vertical direction is defined as a Z-axis direction. The X-axis direction, the Y-axis direction, and the Z-axis direction are directions intersecting one another (orthogonal to one another in the embodiment). Although it may be conceivable that the Z-axis direction is not in the vertical direction depending on a used mode, hereinafter the Z-axis direction is described as the vertical direction for convenience of explanation.

In the following description, for example, an X-axis positive direction indicates an arrow direction side of the X-axis, and an X-axis negative direction indicates an opposite direction to the X-axis positive direction. The same applies to the Y-axis direction and the Z-axis direction. The term “X-axis direction” simply means either one or both directions parallel to the X-axis. The same applies to terms related to the Y-axis and the Z-axis.

An expression indicating a relative direction or a posture such as parallel and orthogonal strictly also includes the case where the expression is not the direction or the posture. For example, two directions orthogonal to each other means not only that the two directions are completely orthogonal to each other, but also that the two directions are substantially orthogonal to each other, namely, includes a difference of, for example, about several percent. In the following description, the expression “insulation” means “electric insulation”.

### EMBODIMENT

### [1. General Description of Energy Storage Apparatus]

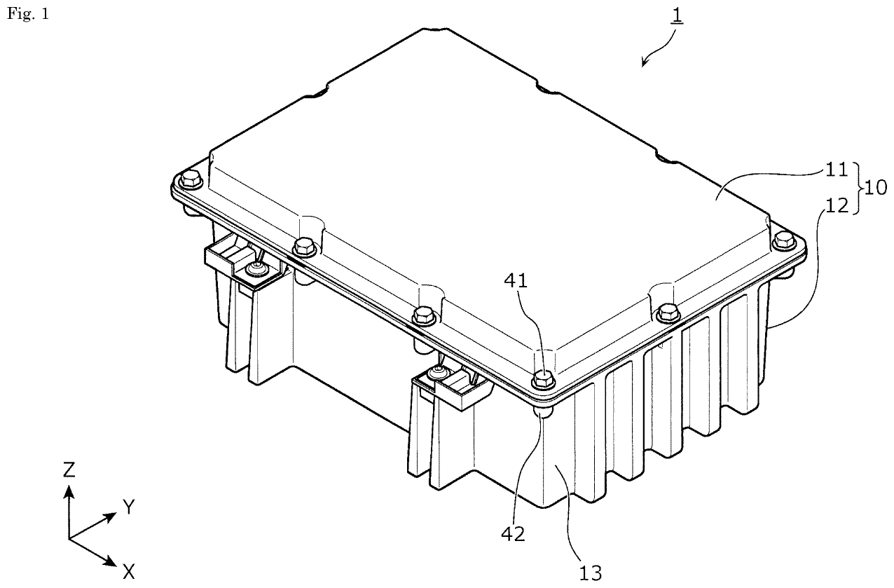

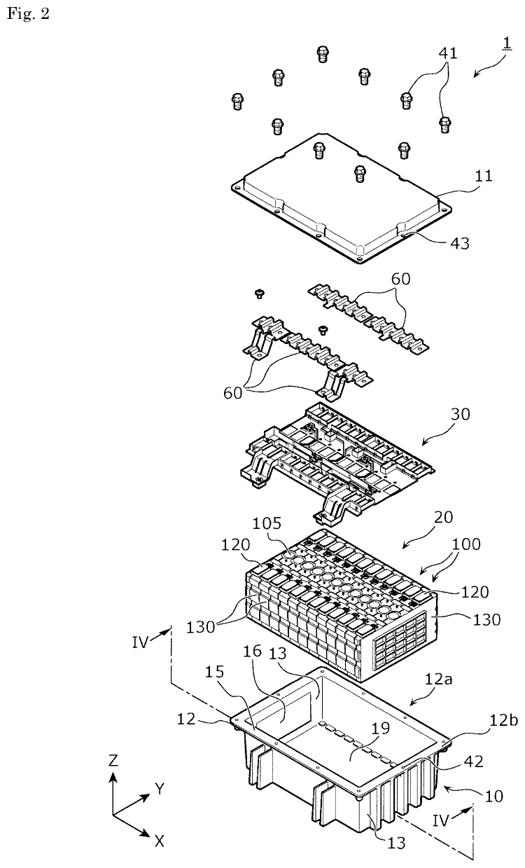

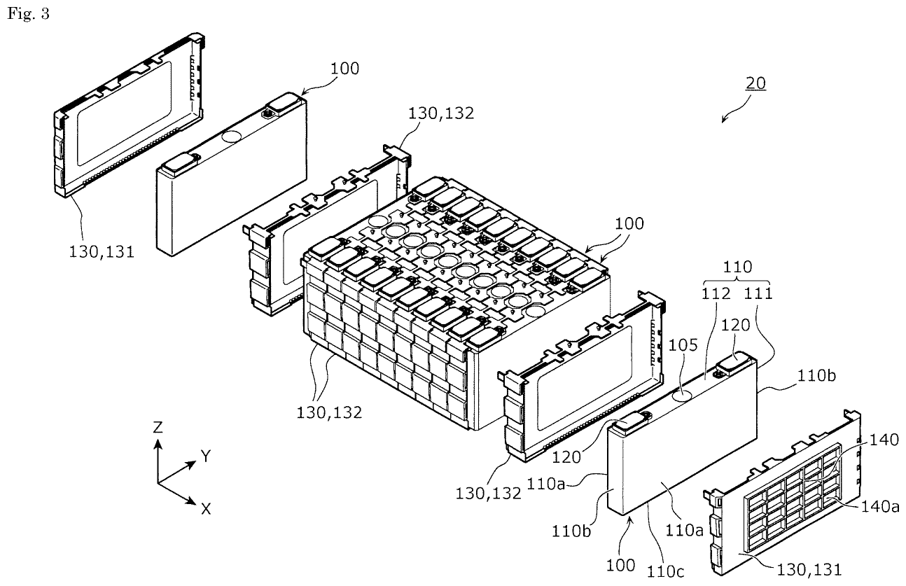

A schematic configuration of an energy storage apparatus 1 according to the embodiment will be described. FIG. 1 is a perspective view illustrating an appearance of the energy storage apparatus 1 according to the embodiment. FIG. 2 is a perspective view illustrating the energy storage apparatus 1 according to the embodiment. FIG. 3 is an exploded perspective view illustrating an energy storage device unit 20 according to the embodiment. In addition to the members illustrated in FIG. 2 and subsequent drawings, temperature- and voltage-measurement sensors, and other members such as an electric wire connected to the sensor are also accommodated in an outer case 10, but illustration and description of these members are omitted.

The energy storage apparatus 1 is an apparatus that can charge electricity from an outside and discharge the electricity to the outside. For example, the energy storage apparatus 1 is a battery module (assembled battery) used for a power storage application, a power supply application, and the like. Specifically, for example, the energy storage apparatus 1 is used as a battery driving or starting an engine of a moving body such as an automobile, a motorcycle, a watercraft, a ship, a snowmobile, an agricultural machine, a construction machine, or a railway vehicle for an electric railway. Examples of the automobile include an electric vehicle (EV), a hybrid electric vehicle (HEV), a plug-in hybrid electric vehicle (PHEV), and a fossil fuel (gasoline, light oil, liquefied natural gas, and the like) automobile. Examples of the railway vehicle for the electric railway include a train, a monorail, a linear motor car, and a hybrid train including both a diesel engine and an electric motor. The energy storage apparatus 1 can also be used as a stationary battery or the like used for home use, business use, or the like.

As illustrated in FIGS. 1 and 2, the energy storage apparatus 1 includes the outer case 10 and the energy storage device unit 20 accommodated in the outer case 10. A bus bar holder 30 that holds bus bars 60 joined to the energy storage device 100 is disposed above the energy storage device unit 20.

The outer case 10 is a box-shaped case (module case) configuring a casing of the energy storage apparatus 1. The outer case 10 is disposed outside the energy storage device unit 20 and the bus bar holder 30, fixes the energy storage device unit 20 and the bus bar holder 30 at a predetermined position, and protects the energy storage device unit 20 and the bus bar holder 30 from an impact or the like. In the embodiment, the outer case 10 is formed of metal such as iron, aluminum, or an aluminum alloy. The rough shape of the outer case 10 (each of the outer case body 12 and the lid body 11) is formed by casting using a mold. As a material forming the outer case 10, resin or the like can also be adopted in addition to the metal. Examples of the resin include polycarbonate (PC), polypropylene (PP), polyethylene (PE), polystyrene (PS), polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), and an ABS resin.

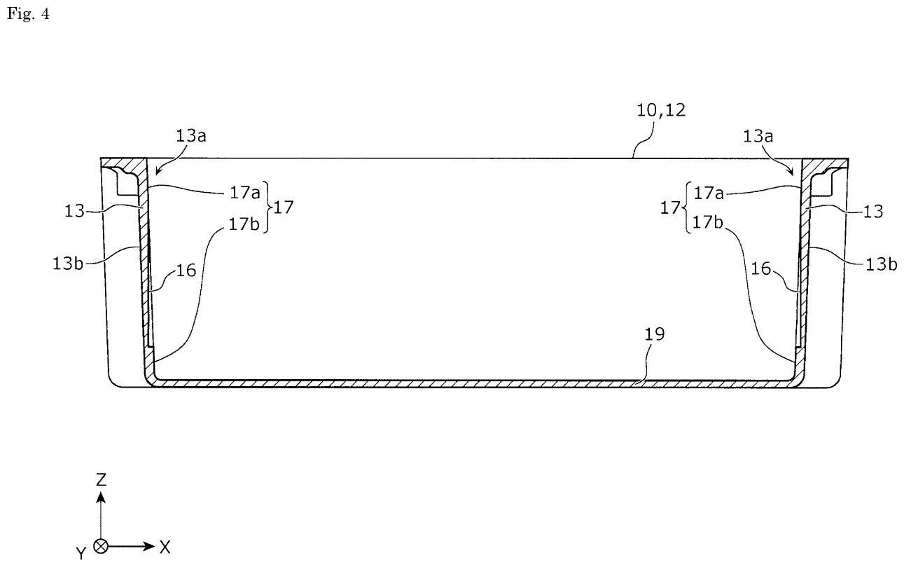

The outer case 10 includes: an opening 12a that is formed on one of both ends in the Z-axis direction and into which the energy storage device unit 20 can be inserted; and a bottom wall 19 that is formed at a position opposite to the opening 12a. Specifically, the outer case 10 includes the outer case body 12 and the lid body 11, and the opening 12a and the bottom wall 19 are formed on the outer case body 12. The outer case body 12 is a bottomed rectangular cylindrical housing in which the opening 12a is formed, and accommodates the energy storage device unit 20. The outer case body 12 has four side walls such as a side wall 15 that partitions the inside and the outside of the outer case 10. The energy storage device unit 20 is surrounded by four side walls of the outer case body 12 in the inside of the outer case 10. Among the four side walls, a pair of side walls 13 is disposed at positions opposite to the energy storage device unit 20 in the X-axis direction. A first vertical surface 16 (see FIG. 2) orthogonal to the X-axis direction is provided on the inside surface of the side wall 13. Effects and the like of the first vertical surface 16 will be described later with reference to FIGS. 4 to 6. The outer case 10 may include an element not illustrated in FIGS. 1 and 2, such as an exhaust tube discharging gas inside the outer case 10 to the outside.

The lid body 11 is a rectangular member that closes the opening 12a of the outer case body 12. The lid body 11 is joined to the outer case body 12 by a plurality of bolts 41, whereby the lid body 11 is fixed to the outer case body 12. Specifically, a through-hole 43 through which the bolt 41 passes is made in a peripheral edge of the lid body 11, and a fixing hole portion 42 is provided in an opening peripheral edge 12b that is a peripheral edge of the opening 12a of the outer case body 12. The bolt 41 is screwed into the fixing hole portion 42 of the outer case body 12 while passing through the through-hole 43 of the lid body 11. Accordingly, the lid body 11 is joined to the opening peripheral edge 12b of the outer case body 12.

The energy storage device unit 20 includes a plurality of energy storage devices 100 and spacers 130 disposed along each of the plurality of energy storage devices 100. The energy storage device 100 is a secondary battery (battery cell) capable of charging and discharging electricity, more specifically, a nonaqueous electrolyte secondary battery such as a lithium ion secondary battery. As illustrated in FIG. 3, the energy storage device 100 includes a case 110 having a flat rectangular parallelepiped shape (square shape) and a pair of (positive electrode and negative electrode) electrode terminals 120 fixed to the case 110. An electrode assembly, a current collector, an electrolyte solution, and the like (not illustrated) are accommodated in the case 110. Examples of the electrode assembly of the energy storage device 100 include a winding-type electrode assembly formed by winding a positive electrode plate and a negative electrode plate with a separator interposed between the positive electrode plate and the negative electrode plate in a layered manner. The energy storage device 100 may include a layered (stacked) electrode assembly formed by stacking a plurality of plate-shaped plates or a bellows-type electrode assembly formed by folding the plates in a bellows shape.

The energy storage device 100 is not limited to the nonaqueous electrolyte secondary battery, but may be a secondary battery except for the nonaqueous electrolyte secondary battery or a capacitor. The energy storage device 100 is not the secondary battery, but may be a primary battery that can use stored electricity without being charged by a user. The energy storage device 100 may be a battery in which a solid electrolyte is used. The energy storage device 100 may be a pouch type energy storage device. The shape of the energy storage device 100 is not limited to the above-described square shape, but may be a polygonal columnar shape, a cylindrical shape, an elliptical columnar shape, an oval columnar shape or the like other than the above-described square shape.

In the embodiment, as illustrated in FIG. 3, the case 110 includes a case body 111 and a lid plate 112 that closes an opening of the case body 111. The case 110 has a structure in which an inside is sealed by joining the case body 111 and the lid plate 112 by welding or the like after the electrode assembly and the like are accommodated in the case body 111. The material of the case 110 (the case body 111 and the lid plate 112) is not particularly limited. The material of the case 110 may be weldable (joinable) metal such as stainless steel, aluminum, an aluminum alloy, iron, or a plated steel plate, and resin can also be used.

The case body 111 has a pair of long side surfaces 110a, a pair of short side surfaces 110b, and a bottom surface 110c disposed at a position opposite to the lid plate 112. The positive and negative electrode terminals 120 and a gas release valve 105 are disposed on the lid plate 112. The gas release valve 105 is a part that is open by receiving an internal pressure of the case 110 when the internal pressure of the case 110 is excessively increased, and thereby discharges the gas inside the case 110 to the outside. In the energy storage device unit 20, the plurality of energy storage devices 100 are arrayed in a posture in which the long side surfaces 110a are directed in the array direction (X-axis direction) and in which the electrode terminals 120 are directed in the Z-axis positive direction. In the embodiment, the X-axis direction is an example of a first direction, and the Z-axis direction is an example of a second direction orthogonal to the first direction. For example, it is described that the outer case 10 includes the opening 12a at one of both ends in the second direction.

The energy storage device unit 20 includes twelve energy storage devices 100 configured as described above. In this embodiment, each of the twelve energy storage devices 100 is disposed between the two spacers 130. The energy storage device unit 20 according to the embodiment includes thirteen spacers 130. Among these spacers 130, the pair of spacers 130 located at both ends in the X-axis direction is referred to as an end spacer 131 when the pair of spacers 130 is distinguished from others. Among these spacers 130, the spacer 130 positioned between two energy storage devices 100 adjacent to each other is referred to as an inter-cell spacer 132 when the spacer 130 positioned between two energy storage devices 100 adjacent to each other is distinguished from others.

In the embodiment, the spacer 130 has a function of holding the energy storage device 100 by a plurality of surfaces expanding in directions intersecting with each other in addition to a function of insulating the case 110 of the energy storage device 100 from another conductive member (including the case 110 of another energy storage device 100) adjacent to the energy storage device 100. The spacer 130 may be referred to as a “holder”, a “cell holder”, or the like. The end spacer 131 may be referred to as an “end holder”.

The spacer 130 is formed of any one of resin materials having an electric insulation property among materials that can be adopted as a material of the outer case 10. The spacer 130 is preferably formed of a material having volume resistivity equal to or more than 1×10¹⁰Ωm. In the embodiment, the end spacer 131 includes a second vertical surface 140 at a position opposite to the first vertical surface 16 of the side wall 13 of the outer case 10. Effects and the like of the second vertical surface 140 will be described later with reference to FIGS. 4 to 6.

The bus bar holder 30 is a flat rectangular insulating member that is disposed opposite to the lid plate 112 of the energy storage device 100 and holds the plurality of bus bars 60. For example, the bus bar holder 30 is formed of any one of resin materials having an electric insulation property among materials that can be adopted as a material of the outer case 10. The bus bar 60 disposed in the bus bar holder 30 is positioned with respect to the electrode terminal 120 to be joined, and in this state, is joined to the electrode terminal 120 by, for example, laser welding. In the embodiment, among the twelve energy storage devices 100 included in the energy storage device unit 20, three consecutively-arrayed energy storage devices 100 are connected in parallel by the bus bars 60. Accordingly, four sets of the energy storage devices 100 connected in parallel are formed. Four sets of energy storage devices 100 are connected in series by three bus bars 60.

The electrode terminals 120 of the energy storage devices 100 in a set of both ends in the four sets of energy storage devices 100 connected in series are the positive electrode (total positive terminal) and the negative electrode (total negative terminal) of the energy storage device unit 20. In the embodiment, the positive electrode terminal 120 of one set (three energy storage devices 100) of the energy storage devices 100 at the ends in the X-axis negative direction out of the twelve energy storage devices 100 is the positive electrode (total positive terminal) of the energy storage device unit 20. The negative electrode terminals 120 of one set (three energy storage devices 100) of the energy storage devices 100 at ends in the X-axis positive direction out of the twelve energy storage devices 100 are the negative electrode (total negative terminal) of the energy storage device unit 20.

Although not illustrated in the drawing, an opening through which the end of the bus bar 60 joined to each of the positive electrode and the negative electrode of the energy storage device unit 20 passes is provided in the side wall 15 of the outer case 10. Ends of these two bus bars 60 are exposed to the outside of the outer case 10 through openings formed on the side walls 15 (see FIG. 1), and function as the positive electrode external terminal and the negative electrode external terminal of the energy storage apparatus 1.

A control device that controls a charge state of the plurality of energy storage devices 100 included in the energy storage device unit 20 and an electric device, such as a relay, may be disposed inside the outer case 10. In this case, the energy storage apparatus 1 may include a positive electrode external terminal and a negative electrode external terminal that are fixed to the lid body 11, and are electrically connected to the energy storage device unit 20 through the electric device and the bus bar 60.

The electric connection mode of the twelve energy storage devices 100 by the bus bars 60 is not limited to the above mode, and all of the twelve energy storage devices 100 may be connected in series by the plurality of bus bars 60. The number of the energy storage devices 100 included in the energy storage device unit 20 is not limited to twelve. The number of energy storage devices 100 included in the energy storage device unit 20 may be at least two.

In the energy storage apparatus 1 having the above-mentioned configuration, the outer case 10 includes a molding process (casting process) in which a mold is used for a manufacturing process of the outer case 10, and includes the inclined side walls 13. Specifically, in the outer case body 12 that is a box-shaped structure including the opening 12a, the side walls 13 opposite to the energy storage device unit 20 in the X-axis direction are inclined outward. As described above, when the energy storage device unit 20 expands in the X-axis direction to press the side wall 13, the side wall 13 can be brought into the state of applying upward reaction force to the energy storage device unit 20. However, in the outer case 10 of the embodiment, the side wall 13 has a configuration in which such the reaction force is hardly generated. Hereinafter, with respect to an energy storage apparatus 1 of the embodiment, a configuration of the side wall 13 and a periphery thereof will be mainly described with reference to FIG. 4 to FIG. 6.

### [2. Configuration of Side Wall and its Periphery]

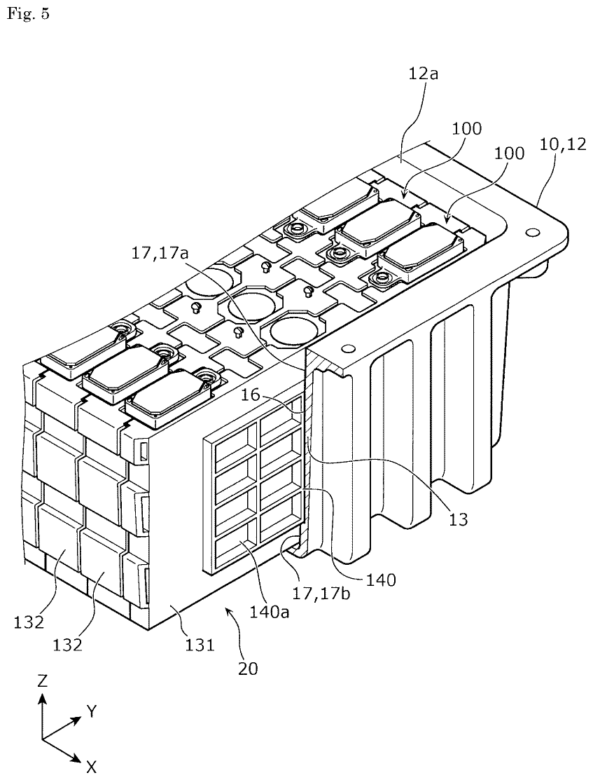

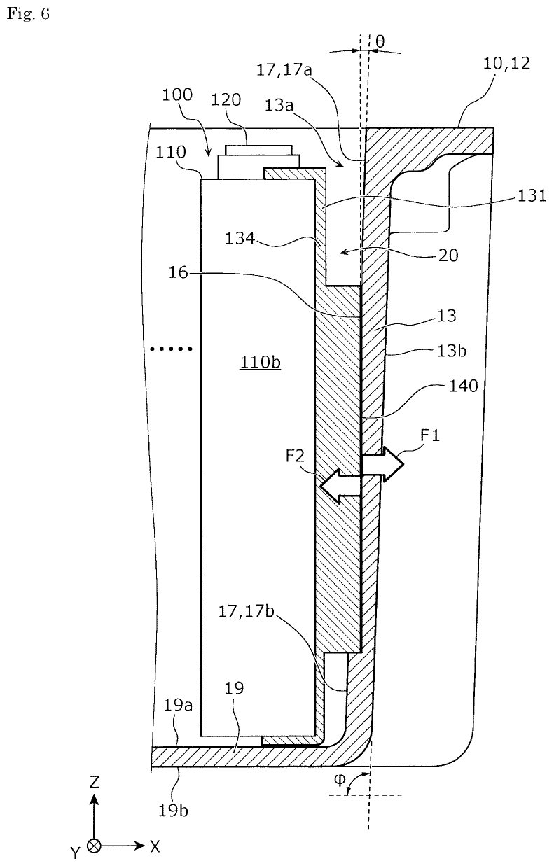

FIG. 4 is a sectional view illustrating the outer case 10 according to the embodiment. FIG. 4 illustrates a section of the outer case body 12 of the outer case 10 taken along line IV-IV in FIG. 2, and does not illustrate the lid body 11. FIG. 5 is a partially cutaway perspective sectional view illustrating a structural relationship between the outer case 10 and the energy storage device unit 20 of the embodiment. FIG. 5 is a perspective view illustrating the state where the outer case 10 in which the energy storage device unit 20 is accommodated is cut along an XZ-plane that passes through line IV-IV in FIG. 2. FIG. 6 is a sectional view illustrating a structural relationship between the energy storage device unit 20 and the side wall 13 of the outer case 10 of the embodiment. In FIG. 6, sections of the outer case body 12 and the end spacer 131 are illustrated at the same position as FIG. 4, and a side surface of the energy storage device 100 as viewed in the Y-axis negative direction is simply illustrated. In the energy storage device unit 20, only the end spacer 131 at the end in the X-axis positive direction and one energy storage device 100 disposed along the end spacer 131 are illustrated, and other spacers 130 and the energy storage devices 100 are not illustrated.

In the embodiment, the pair of side walls 13 opposite to each other in the X-axis direction has a common configuration (see FIG. 4). Hereinafter, configurations of the side wall 13 in the X-axis positive direction out of the pair of side walls 13 and the periphery thereof will be described, and the description of the side wall 13 in the X-axis negative direction will be omitted.

As illustrated in FIG. 4 to FIG. 6, the outer case body 12 of the outer case 10 is a case that accommodates the energy storage device unit 20 in the outer case body 12. The outer case body 12 has a pair of side walls 13 opposite to each other in the X-axis direction that is the array direction (stacking direction) of the energy storage devices 100 in the energy storage device unit 20. In the embodiment, the outer case 10 is formed of metal such as iron, aluminum, or an aluminum alloy. Specifically, the manufacturing of the outer case body 12 includes a casting process, and the plurality of walls (including the pair of side walls 13) extending from the bottom wall 19 in the Z-axis positive direction has a draft angle (inclination).

As illustrated in FIG. 6, when the bottom wall 19 is in a posture parallel to the XY-plane, an angle (inclination angle φ) formed by the bottom wall 19 and the side wall 13 is larger than 90°. In the embodiment, the reference surface of the bottom wall 19 with respect to the inclination angle q is an inner bottom surface 19a of the bottom wall 19, and the reference surface of the side wall 13 is an outside surface 13b. In the section parallel to the XZ-plane, it can be expressed that the angle (inclination angle φ) formed by the inner bottom surface 19a of the bottom wall 19 and the outside surface 13b of the side wall 13 is larger than 90°.

As described above, the side wall 13 in the X-axis positive direction is inclined in a direction away from the energy storage device unit 20 (X-axis positive direction) as the side wall 13 extends farther from the bottom wall 19 (advances in the Z-axis positive direction). The side wall 13 is inclined outward.

More specifically, immediately after the outer case body 12 is taken out from the mold, both the inside surface 13a and the outside surface 13b (see FIG. 6) of the side wall 13 are inclined surfaces inclined outward as a whole. It is assumed that the case where the entire inside surface 13a remains as the inclined surface. In this case, when the energy storage device unit 20 is expanded in the X-axis direction by expansion of at least one energy storage device 100, whereby the inside surface 13a of the side wall 13 is pressed from the end of the energy storage device unit 20, and as a result, a component in the Z-axis positive direction in the reaction force of the side wall 13 is generated. The reaction force includes a component lifting up the end of the energy storage device unit 20. As the expansion of the energy storage device unit 20 in the X-axis direction increases, the reaction force lifting up the end also increases, and there is a possibility that the energy storage device unit 20 is displaced upward. When the end of the energy storage device unit 20 is displaced upward, a defect such as damage of a connection portion between the energy storage device unit 20 and another member such as the bus bar 60 may be generated.

On at least a part of the inside surface 13a of the side wall 13 of the embodiment, the first vertical surface 16 perpendicular to the array direction (X-axis direction) of the energy storage devices 100 in the energy storage device unit 20 is provided. Specifically, the first vertical surface 16 is provided on the inside surface 13a at a position where the first vertical surface 16 is opposite to the energy storage device unit 20 in the X-axis direction. With such the configuration, when the energy storage device unit 20 expands in the X-axis direction (when an entire length of the energy storage device unit 20 in the X-axis direction extends), the end in the X-axis direction of the energy storage device unit 20 presses the first vertical surface 16. The first vertical surface 16 pressed in the X-axis direction by the energy storage device unit 20 can push back the energy storage device unit 20 by the reaction force in the direction parallel to the X-axis direction. Accordingly, the upward displacement of the energy storage device unit 20 is prevented. For example, such the first vertical surface 16 is formed by cutting the inside surface 13a of the side wall 13.

In the embodiment, the inside surface 13a of the side wall 13 is formed substantially parallel to the outside surface 13b of the side wall 13 except for the first vertical surface 16. Although the reference surface of the side wall 13 with respect to the inclination angle φ of the side wall 13 is the outside surface 13b in FIG. 6, the reference surface may be the inside surface 13a. When the inclination angle of the inside surface 13a with respect to the direction (reference direction) perpendicular to the X-axis direction is θ (see FIG. 6), the inclination angle φ of the side wall 13 is an inclination angle θ+90° of the inside surface 13a. It can also be said that the inclination angle of the side wall 13 with respect to the reference direction is θ. The same applies to the reference surface of the bottom wall 19 with respect to the inclination angle φ of the side wall 13, and because the inner bottom surface 19a and the outer bottom surface 19b (see FIG. 6) of the bottom wall 19 are parallel, the reference surface may be the outer bottom surface 19b instead of the inner bottom surface 19a.

As described above, the energy storage apparatus 1 according to one aspect of the present invention includes: the energy storage device unit 20 including the plurality of energy storage devices 100 arrayed in the X-axis direction that is the first direction; and the outer case 10 accommodating the energy storage device unit 20. The outer case 10 includes the opening 12a at the end in the Z-axis direction that is the second direction orthogonal to the X-axis direction. The outer case 10 includes the bottom wall 19 opposite to the opening 12a and the side wall 13 connected to the bottom wall 19. The side wall 13 is opposite to the energy storage device unit 20 in the X-axis direction, and is inclined in the direction away from the energy storage device unit 20 as the side wall 13 extends farther from the bottom wall 19. The side wall 13 includes the first vertical surface 16 that is a plane perpendicular to the X-axis direction on at least a part in the Z-axis direction of the inside surface 13a opposite to the energy storage device unit 20 in the X-axis direction.

As described above, in the energy storage apparatus 1 of the embodiment, the side wall 13 opposite to the energy storage device unit 20 in the X-axis direction that is the array direction of the energy storage devices 100 are inclined in the direction away from the energy storage device unit 20 as the side wall 13 extends farther from the bottom wall 19. That is, due to a manufacturing method using the mold such as the mold for casting metal, the inside surface 13a and the outside surface 13b of the side wall 13 are inclined outward as a whole. However, the plane (first vertical surface 16) perpendicular to the X-axis direction is provided in the inside surface 13a of the side wall 13. With such the configuration, when the energy storage device unit 20 expands in the X-axis direction to press the side wall 13, as illustrated in FIG. 6, pressing force F1 of the energy storage device unit 20 acts on the first vertical surface 16 in a normal direction (the direction parallel to the X-axis direction) of the first vertical surface 16. As a result, the side wall 13 can be pushed back by reaction force F2 in the direction parallel to the X-axis direction. Accordingly, force of the upward (Z-axis positive direction) component included in the reaction force by the side wall 13 is prevented. The reaction force F2 generated by the side walls 13 efficiently acts on the energy storage device unit 20 as force preventing the expansion of the energy storage device unit 20 that tends to expand in the X-axis direction. According to the energy storage apparatus 1 of the embodiment, the displacement of the energy storage device unit 20 can be prevented while preventing the expansion of the energy storage device unit 20. As a result, a possibility of generating the defect due to the displacement of the energy storage device unit 20 is reduced. The energy storage apparatus 1 of the embodiment is an energy storage apparatus with high reliability.

More specifically, the first vertical surface 16 does not need to be strictly perpendicular to the X-axis direction. When the inclination angle θ (see FIG. 6) of the inside surface 13a of the side wall 13 inclined by the draft angle with respect to the direction (reference direction) perpendicular to the X-axis direction is defined, the inclination angle of the first vertical surface 16 with respect to the reference direction may be less than 0. When the inclination angle of first vertical surface 16 with respect to the reference direction is smaller than the inclination angle of the inside surface 13a, the component in the Z-axis positive direction in the reaction force generated by side wall 13 becomes smaller than that in the case where the first vertical surface 16 does not exist on inside surface 13a. The energy storage device unit 20 is less likely to be displaced in the Z-axis positive direction. The inclination angle caused by the draft angle is generally about 1° to about 3°. Consequently, when the inclination angle of the first vertical surface 16 with respect to the reference direction is less than 0, it can be expressed that the first vertical surface 16 is substantially parallel to the reference direction, namely, perpendicular to the X-axis direction.

In the embodiment, the energy storage device unit 20 includes the end spacer 131 between the plurality of energy storage devices 100 and the side wall 13. The end spacer 131 includes the second vertical surface 140 that is a plane perpendicular to the X-axis direction on at least a part of the side surface opposite to the side wall 13.

In the embodiment, as illustrated in FIGS. 3, 5, and 6, in the end spacer 131, the second vertical surface 140 is formed by the end surface in the X-axis direction of the portion protruding from the spacer body 134 in the X-axis direction. The second vertical surface 140 includes a plurality of recesses 140a formed by lightening for weight reduction and the like, and as a result, a grid-like surface is disposed on the end spacer 131 as the second vertical surface 140. As described above, the second vertical surface 140 disposed on the end spacer 131 is disposed so as to be opposed to the first vertical surface 16 in the X-axis direction while the energy storage device unit 20 is accommodated inside the outer case 10.

With such the configuration, when the energy storage device unit 20 expands in the X-axis direction, as illustrated in FIG. 6, the side wall 13 and the energy storage device unit 20 are pressed against each other in the X-axis direction while the first vertical surface 16 and the second vertical surface 140 are brought into surface contact with each other. Consequently, the force that the energy storage device unit 20 applies to the side wall 13 is dispersed by the first vertical surface 16 and the expansion of the energy storage device unit 20 can be stably prevented. Relatively large frictional force generated by the contact between the wide surfaces more reliably prevents the movement of the energy storage device unit 20 in the direction away from the bottom wall 19.

In the embodiment, the opening 12a allows the energy storage device unit 20 to be inserted, and an inclined surface 17 that is inclined in the direction away from the energy storage device unit 20 as the side surface 14 extends farther from the bottom wall 19 at the position continuous with the first vertical surface 16 in the Z-axis direction is provided in the inside surface 13a of the side wall 13.

With such the configuration, the inclined surface 17 is formed on a part of the inside surface 13a of the side wall 13, so that the inclined surface 17 functions as a guide when the energy storage device unit 20 is inserted into the outer case 10. With such the configuration, the energy storage device unit 20 can be efficiently accommodated in the outer case 10.

The inclined surface 17 is formed by, for example, the draft angle. That is, on the inside surface 13a of the side wall 13, the portion other than the first vertical surface 16 formed by cutting or the like has the draft angle (inclination) as it is. As a result, the inclined surface 17 is provided on a part of the inside surface 13a.

In the embodiment, the inclined surface 17 includes a first inclined surface 17a provided at the end of inside surface 13a, the end being far from the bottom wall 19, out of both ends of the inside surface 13a in the Z-axis direction. That is, the inclined surface 17 includes the first inclined surface 17a provided at the end of the inside surface 13a in the Z-axis direction. The end is an end far from the bottom wall 19 out of both ends of the inside surface 13a in the Z-axis direction.

With such the configuration, the first inclined surface 17a functions as an insertion guide at the start of the work of inserting the energy storage device unit 20 into the opening 12a. When observed from the upper end toward the lower end of the side wall 13, as illustrated in FIG. 6, the first inclined surface 17a exists first, and then the first vertical surface 16 starts. The position of the first vertical surface 16 in the X-axis direction is relatively far from the outside surface 13b of the side wall 13. Even when the side wall 13 is relatively thin, the thickness of the side wall 13 at the end of the first vertical surface 16 closest to the bottom wall 19 can be secured to the thickness that satisfies the requirements of safety and the like.

In the embodiment, the inclined surface 17 includes a second inclined surface 17b provided at the end close to the bottom wall 19 out of both ends of the inside surface 13a in the Z-axis direction. That is, the inclined surface 17 includes the second inclined surface 17b provided at the end of the inside surface 13a in the Z-axis direction. The end is an end close to the bottom wall 19 out of both ends of the inside surface 13a in the Z-axis direction.

When the first vertical surface 16 exists up to the position reaching the bottom wall 19 while the second inclined surface 17b does not exist, the wall thickness of the side wall 13 at the position of the lower end of the first vertical surface 16 becomes thinner. In this regard, in the embodiment, the second inclined surface 17b is provided at the end close to the bottom wall 19 of the inside surface 13a. The wall thickness of the side wall 13 at the position of the lower end of the first vertical surface 16 can be secured to the thickness that satisfies the requirements of safety and the like. The second inclined surface 17b also functions as the insertion guide at the end of the work of inserting the energy storage device unit 20 into the outer case 10.

### [3. Modifications]

Although the energy storage apparatus 1 of the embodiment of the present invention is described above, the present invention is not limited to the embodiment. The embodiment disclosed herein is illustrative in all respects and is not restrictive, and the scope of the present invention includes all modifications within the meaning and scope equivalent to the claims.

The inclined surface 17 may not be provided on the inside surface 13a of the side wall 13. The first vertical surface 16 may be provided in the entire region of the inside surface 13a in the Z-axis direction. Even in this case, when the wall thickness of the side wall 13 at the time point before the formation of the first vertical surface 16 is relatively thick, the thickness of the side wall 13 at the position of the lower end of the first vertical surface 16 can be secured to the thickness that satisfies the requirements of safety and the like.

In the embodiment, each of the pair of side walls 13 opposite to each other in the X-axis direction has the common configuration, but these side walls 13 may have different configurations. One of the pair of side walls 13 may include the first vertical surface 16, and the other side wall 13 may not include the first vertical surface 16. Even in this case, the upward displacement due to the reception of the reaction force from the side wall 13 is hardly generated for at least the end opposite to the first vertical surface 16 out of the both ends of the energy storage device unit 20 in the X-axis direction.

A portion of the inside surface 13a of the side wall 13 other than the first vertical surface 16 may not be parallel to the outside surface 13b of the side wall 13. In this case, when the outside surface 13b is inclined, it can be expressed that the side wall 13 is inclined. On the side wall 13 (see FIG. 6) in the X-axis positive direction out of the pair of side walls 13, the outside surface 13b is inclined in the direction away from the energy storage device unit 20 (X-axis positive direction) as the outside surface 13b extends away from the bottom wall 19 (advances in the Z-axis positive direction). Consequently, in this case, it can be expressed that the side wall 13 is inclined in the direction away from the energy storage device unit 20 (inclined outward) as the side wall 13 extends farther from the bottom wall 19.

The inclination angle of the first inclined surface 17a in the inside surface 13a of the side wall 13 with respect to the reference direction and the inclination angle of the second inclined surface 17b with respect to the reference direction may not be the same. When cutting or the like is performed on the first inclined surface 17a having the draft angle of about 1° to about 3°, the inclination angle of the first inclined surface 17a with respect to the reference direction may be set to the angle larger than 3°. Accordingly, the energy storage device unit 20 can be more easily inserted into the outer case 10.

The second vertical surface 140 included in the end spacer 131 may not have the recess 140a formed by lightening. The second vertical surface 140 may be a simple plane without unevenness.

The size and shape of the first vertical surface 16 need not be the size and shape illustrated in FIGS. 2, 4, 6, and the like. The first vertical surface 16 may be provided over the entire region of the inside surface 13a of the side wall 13 in the Y-axis direction. The first vertical surface 16 may be formed stepwise instead of the single plane. The first vertical surface 16 is two planes perpendicular to the X-axis direction, and may include a plane close to the energy storage device unit 20 and a plane far from the energy storage device unit 20. In this case, each plane may be referred to as the “first vertical plane”. The side wall 13 may include a plurality of first vertical surfaces in which the positions in the X-axis direction are different from each other. Even in this case, as long as the portion that can be brought into surface contact with both of the two first vertical surfaces is formed at the end of the energy storage device unit 20 opposite to the side wall 13, the side wall 13 can apply the reaction force in the direction substantially parallel to the X-axis to the energy storage device unit 20. The displacement of the energy storage device unit 20 can be prevented while the expansion of the energy storage device unit 20 is prevented.

In the embodiment, the width of the first vertical surface 16 in the Y-axis direction is equal to or greater than the width of the second vertical surface 140 of the end spacer 131 in the Y-axis direction that is in direct contact with the first vertical surface 16. The width of first vertical surface 16 in the Z-axis direction is substantially equal to the width of second vertical surface 140 of end spacer 131 in the Z-axis direction. With such the configuration, the first vertical surface 16 can be brought into contact with the substantially entire region of the second vertical surface 140, and the expansion in the X-axis direction of the energy storage device unit 20 can be efficiently prevented. However, the width of first vertical surface 16 in the Z-axis direction may be smaller than the width of second vertical surface 140 in the Z-axis direction. In FIG. 6, the first inclined surface 17a may be disposed from the upper end of the side wall 13 to the position opposite to the second vertical surface 140 in the X-axis direction. A part of the second vertical surface 140 may not be able to come into contact with the first vertical surface 16. However, from the viewpoint of efficiently preventing the expansion of the energy storage device unit 20, it is preferable that the first vertical surface 16 and the second vertical surface 140 are arrayed opposite to each other in the X-axis direction at the position opposite to the center portion in the Z-axis direction of the case 110 of the energy storage device 100 in FIG. 6.

The energy storage device unit 20 may not include the plurality of spacers 130. When the energy storage device 100 at the end in the axial direction of the energy storage device unit 20 includes the insulating member that covers the outer surface of the case 110, the long side surface 110a (see FIG. 3) of the case 110 may be brought into contact with the first vertical surface 16 of the side wall 13. When the outer case 10 is made of resin such as PP or PE instead of metal, the long side surface 110a of the case 110 may be brought into directly contact with the first vertical surface 16 of the side wall 13.

Each of the plurality of spacers 130 may not have a shape holding the energy storage device 100 on a plurality of surfaces as illustrated in FIG. 3. Each of the plurality of spacers 130 may be a simple flat-plate member disposed along the long side surface 110a of the energy storage device 100.

The energy storage device unit 20 may include not only the plurality of energy storage devices 100 and the plurality of spacers 130 but also the plurality of bus bars 60 and the bus bar holder 30 (see FIG. 2) joined to the electrode terminals 120 of the plurality of energy storage devices 100. The configuration in which the bus bar holder 30 and the plurality of bus bars 60 are added to the energy storage device unit 20 of the embodiment may be referred to as the “energy storage device unit”.

A form constructed by any combination of the components included in the embodiment and the modification described above is also included in the scope of the present invention.

### INDUSTRIAL APPLICABILITY

The present invention can be applied to the energy storage apparatus including the energy storage device such as a lithium ion secondary battery.

### DESCRIPTION OF REFERENCE SIGNS

1: energy storage apparatus
10: outer case
12: outer case body
12a: opening
13, 15: side wall
13a: inside surface
13b: outside surface
16: first vertical plane
17: inclined surface
17a: first inclined surface
17b: second inclined surface
19: bottom wall
19a: inner bottom surface
19b: outer bottom surface
20: energy storage device unit
100: energy storage device
110: case
110a: long side surface
110b: short side surface
110c: bottom surface
130: spacer
131: end spacer
140: second vertical plane
140a: recess

1. An energy storage apparatus comprising:
an energy storage device unit including a plurality of energy storage devices arrayed in a first direction; and
an outer case accommodating the energy storage device unit, the outer case including an opening at an end in a second direction orthogonal to the first direction, wherein
the outer case includes:
a bottom wall opposite to the opening in the second direction; and
a side wall being connected to the bottom wall and being opposite to the energy storage device unit in the first direction, the side wall being inclined in a direction away from the energy storage device unit as the side wall extends farther from the bottom wall, and
the side wall includes a first vertical surface being a plane perpendicular to the first direction on at least a part of an inside surface in the second direction, the inside surface being opposite to the energy storage device unit in the first direction.

2. The energy storage apparatus according to claim 1, wherein
the energy storage device unit further includes an end spacer between the plurality of energy storage devices and the side wall, and
the end spacer includes a second vertical surface being a plane perpendicular to the first direction on at least a part of a side surface opposite to the side wall.

3. The energy storage apparatus according to claim 1, wherein
the energy storage device unit can be inserted into the opening, and
an inclined surface is provided on the inside surface of the side wall at a position continuous to the first vertical surface in the second direction, the inclined surface being inclined in a direction away from the energy storage device unit as the side wall extends farther from the bottom wall.

4. The energy storage apparatus according to claim 3, wherein the inclined surface includes a first inclined surface provided at an end far from the bottom wall out of both ends of the inside surface in the second direction.

5. The energy storage apparatus according to claim 3, wherein the inclined surface includes a second inclined surface provided at an end close to the bottom wall out of both ends of the inside surface in the second direction.
